(19) United States
(12) Patent Application Publication
(10) Pub. No.: US 2020/0249057 A1
(43) Pub. Date: Aug. 6, 2020

(54) Vortex Flowmeter

(71) Applicant: CDI Meters, Inc., Woburn, MA (US)

(72) Inventor: Roger E. Dennison, Lexington, MA (US)

(21) Appl. No.: 16/782,487

(22) Filed: Feb. 5, 2020

Related U.S. Application Data
(60) Provisional application No. 62/801,331, filed on Feb. 5, 2019.

(51) Int. Cl. G01F 1/32

(52) U.S. Cl. CPC G01F 1/3236

(57) ABSTRACT

A vortex flowmeter configured for ease of installation in a pipe, having a shedder bar which enters the pipe through a hole and has its distal end constrained by direct or indirect frictional contact with the opposite wall of the pipe.

### CROSS-REFERENCE TO RELATED APPLICATION

This application claims priority of Provisional Patent Application 62/801,331 filed on Feb. 5, 2019.

### FIELD

A vortex flowmeter designed to facilitate installation in a pipeline.

### BACKGROUND

Vortex flowmeters are commonly made in one of three designs: an in-line design in which the body of the flowmeter encircles the flow and the shedder bar extends across the flow, an insertion design in which the shedder bar is anchored in fittings on opposite sides of a pipe, and an insertion design which incorporates a housing that the shedder bar traverses, said housing being inserted into a pipe. All three designs present difficulties for installation. The first requires that the pipe be completely severed. The second requires that holes be drilled on opposite sides of the pipe, and the third requires that a large hole be drilled, in order to accommodate the housing surrounding the shedder bar.

### SUMMARY

The subject invention relates to a vortex flowmeter that can be installed to measure flow in a pipe through a single, relatively small hole in the wall of the pipe. It incorporates means of adjusting the depth of penetration of the shedder bar into the pipe, means of anchoring the shedder bar to the opposite pipe wall, means of dampening vibrations that may be induced into the shedder bar by the moving fluid, means of sealing the meter to the outside of the pipe, and means of sensing vortices and computing flow.

All examples and features mentioned below can be combined in any technically possible way.

In one aspect, a vortex flowmeter includes a vortex-generating bar that is configured to be inserted into a pipe through a hole in a first wall of the pipe and span the pipe, and comprises a distal end that makes direct or indirect contact with a second pipe wall that is opposite the first wall of the pipe, and an anchoring structure located outside of the pipe and that is mechanically coupled to the vortex-generating bar and configured to hold the vortex-generating bar in the pipe.

Some examples include one of the above and/or below features, or any combination thereof. In an example the vortex flowmeter further comprises an elastomeric member located between the distal end of the vortex-generating bar and the opposite wall of the pipe, to damp vibrations of the vortex-generating bar. In some examples the anchoring structure comprises a split ring. In an example the split ring encircles the pipe. In an example there is a gasket between the split ring and the pipe.

Some examples include one of the above and/or below features, or any combination thereof. In an example the anchoring structure is internally threaded. In an example the vortex-generating bar is threaded and is configured to engage the anchoring structure threads, to allow for adjustment of the depth of insertion of the vortex-generating bar in the pipe. In an example there is also an o-ring seal between the vortex-generating bar and the anchoring structure, to inhibit leakage of fluid from the pipe. In an example the vortex flowmeter also includes an electronics enclosure carried by the anchoring structure. In an example the electronics enclosure comprises a base that is coupled to the anchoring structure and is separable from an upper portion. In an example the upper portion of the electronics enclosure is configured to be rotated along with the vortex-generating bar.

Some examples include one of the above and/or below features, or any combination thereof. In an example the pipe contains a flowing fluid with an overall direction of flow, and the vortex-generating bar comprises a transverse hole through the vortex-generating bar. In an example there is a sensing vane in the transverse hole through the vortex-generating bar.

In another aspect a vortex flowmeter includes a vortex-generating bar that is configured to be inserted into a pipe through a hole in a first wall of the pipe and span the pipe, and comprises a distal end that makes direct or indirect contact with a second pipe wall that is opposite the first wall of the pipe, wherein the pipe contains a flowing fluid with an overall direction of flow, and wherein the vortex-generating bar comprises a transverse hole through the vortex-generating bar and a sensing vane in the transverse hole, an elastomeric member located between the distal end of the vortex-generating bar and the opposite wall of the pipe, to damp vibrations of the vortex-generating bar, an internally-threaded split ring located outside of the pipe and encircling the pipe, wherein the split ring is mechanically coupled to the vortex-generating bar and configured to hold the vortex-generating bar in the pipe, and further comprising an a-ring seal between the vortex-generating bar and the split ring, to inhibit leakage of fluid from the pipe and a gasket between the split ring and the pipe. The vortex-generating bar is threaded and is configured to engage the split ring threads, to allow for adjustment of the depth of insertion of the vortex-generating bar in the pipe.

Some examples include one of the above and/or below features, or any combination thereof. In an example the vortex flowmeter further comprises an electronics enclosure carried by the split ring. In an example the electronics enclosure comprises a base that is coupled to the split ring and is separable from an upper portion. In an example the upper portion of the electronics enclosure is configured to be rotated along with the vortex-generating bar.

### BRIEF DESCRIPTION OF THE DRAWINGS

Other objects, features and examples will occur to those skilled in the art from the following description and the accompanying drawings, in which:

FIG. 1 is a partial sectional view illustrating components of the proposed flowmeter mounted on a pipe.

FIG. 2 is a cross-sectional view through the probe or shedder bar.

### DETAILED DESCRIPTION

This disclosure pertains to a vortex flowmeter requiring a single small hole in a pipe for installation.

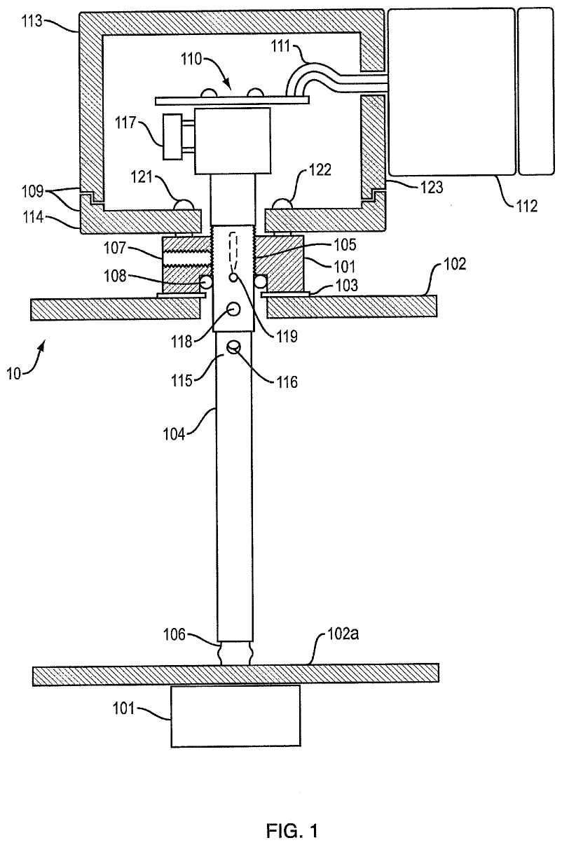

FIG. 1 illustrates elements of the flowmeter 10. An anchoring structure such as a split ring, 101, mounts circumferentially around pipe 102 and seals to it by means of gasket 103. A probe 104 (i.e., a “shedder bar”) is secured to the split ring by a mating thread 105 internal to the split ring and external to the probe. Probe 104 extends across the pipe to the opposite wall 102a. Probe 104 terminates in an elastomeric piece, 106, which presses against the wall of the pipe, creating a mechanical connection through a material, such as Viton rubber, with vibration-dampening properties. The threaded connection allows the depth of insertion of the probe to be adjusted, compensating for limited variations in the dimensions of the pipe and ensuring that the elastomeric piece is properly compressed. Elastomeric piece 106 may not be necessary; the distal end of the probe could directly contact the pipe wall. Alternatively the distal end of the probe could be made from or could directly carry a vibration-absorbing structure such as an elastomeric member. Set screw 107 secures the probe in the proper orientation while o-ring 108 prevents leakage of fluid out of the pipe along the thread.

Enclosure 109 shields electronic circuit 110 from electromagnetic interference. Wires 111 provide signal and power connections to an outside circuit, not shown, in a second enclosure 112 that provides signal processing and display and connects to a source of power, not shown. Enclosure 109 includes base 114 that is removably connected to split ring 101 via screws 121 and 122. To permit the probe to be turned in order to adjust its depth in the pipe, the upper portion of the enclosure, 113, can be separated from its base, 114 as indicated by shoulder joint 123. When the probe is rotated to adjust its position, the upper portion of the enclosure, 113, and the attached second enclosure, 112, can be rotated with it to prevent the attaching wires, 111, from becoming excessively twisted. The upper portion of the enclosure can also be rotated 180 degrees relative to the base to orient the display as desired. The upper portion of the enclosure and the base are attached by screws, not shown. Also visible in FIG. 1 are transverse hole 115 and a sensing vane 116, used in sensing flow.

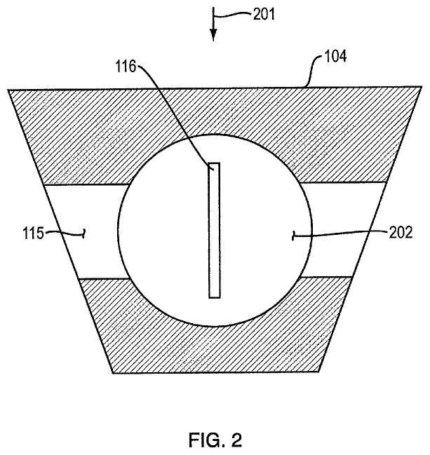

FIG. 2 is a sectional view through shedder bar 104 at hole 115. Shedder bars for vortex flowmeters are known in the field. Arrow 201 shows the overall direction of flow. As flow impinges on the bar, the fluid moves alternately toward one side and then the other, generating vortices and thus creating pressure differences between the two sides of the bar. Transverse hole 115 allows the pressure difference to push sensing vane 116 from side to side. Clearance 202 is provided to permit the vane to move. The sensing vane may be a piezoelectric film element generating electrical signals as it flexes in response to the pressure changes. These signals are amplified and filtered by electronic circuit 110 and transmitted to a microprocessor in enclosure 112 which determines their frequency. Volumetric flow is, to a good approximation, directly proportional to this frequency; the microprocessor determines volumetric flow by multiplying the frequency by a constant determined during calibration, or by use of a lookup table, generated during calibration, relating vortex frequency to flow.

Additional features permit the meter to determine mass flow of a known gas. Absolute pressure sensor 117, communicating through a passage (not shown) with hole 118, senses the pressure in the pipe. A thermistor 119, within the probe and shown hidden, senses the pipe temperature. Using well-known analog linearization circuitry, the thermistor produces a voltage signal which is converted to digital form by an analog to digital convertor in circuit 110 and then transmitted to the microcontroller in enclosure 112 for further linearization. The microcontroller divides the pressure by the absolute temperature and by the gas constant to obtain density, and multiplies density by volumetric flow to obtain mass flow.

A number of implementations have been described. Nevertheless, it will be understood that additional modifications may be made without departing from the scope of the inventive concepts described herein, and, accordingly, other examples are within the scope of the following claims.

What is claimed is:

1. A vortex flowmeter, comprising:
a vortex-generating bar that is configured to be inserted into a pipe through a hole in a first wall of the pipe and span the pipe, and comprises a distal end that makes direct or indirect contact with a second pipe wall that is opposite the first wall of the pipe; and
an anchoring structure located outside of the pipe and that is mechanically coupled to the vortex-generating bar and configured to hold the vortex-generating bar in the pipe.

2. The vortex flowmeter of claim 1, further comprising an elastomeric member located between the distal end of the vortex-generating bar and the opposite wall of the pipe, to damp vibrations of the vortex-generating bar.

3. The vortex flowmeter of claim 1, wherein the anchoring structure comprises a split ring.

4. The vortex flowmeter of claim 3, wherein the split ring encircles the pipe.

5. The vortex flowmeter of claim 3, further comprising a gasket between the split ring and the pipe.

6. The vortex flowmeter of claim 1, wherein the anchoring structure is internally threaded.

7. The vortex flowmeter of claim 6, wherein the vortex-generating bar is threaded and is configured to engage the anchoring structure threads, to allow for adjustment of the depth of insertion of the vortex-generating bar in the pipe.

8. The vortex flowmeter of claim 7, further comprising an o-ring seal between the vortex-generating bar and the anchoring structure, to inhibit leakage of fluid from the pipe.

9. The vortex flowmeter of claim 8, further comprising an electronics enclosure carried by the anchoring structure.

10. The vortex flowmeter of claim 9, wherein the electronics enclosure comprises a base that is coupled to the anchoring structure and is separable from an upper portion.

11. The vortex flowmeter of claim 10, wherein the upper portion of the electronics enclosure is configured to be rotated along with the vortex-generating bar.

12. The vortex flowmeter of claim 1, wherein the pipe contains a flowing fluid with an overall direction of flow, and wherein the vortex-generating bar comprises a transverse hole through the vortex-generating bar.

13. The vortex flowmeter of claim 12, further comprising a sensing vane in the transverse hole through the vortex-generating bar.

14. A vortex flowmeter comprising:
a vortex-generating bar that is configured to be inserted into a pipe through a hole in a first wall of the pipe and span the pipe, and comprises a distal end that makes direct or indirect contact with a second pipe wall that is opposite the first wall of the pipe, wherein the pipe contains a flowing fluid with an overall direction of flow, and wherein the vortex-generating bar comprises a transverse hole through the vortex-generating bar and a sensing vane in the transverse hole;
an elastomeric member located between the distal end of the vortex-generating bar and the opposite wall of the pipe, to damp vibrations of the vortex-generating bar;
an internally-threaded split ring located outside of the pipe and encircling the pipe, wherein the split ring is mechanically coupled to the vortex-generating bar and configured to hold the vortex-generating bar in the pipe, and further comprising an o-ring seal between the vortex-generating bar and the split ring, to inhibit leakage of fluid from the pipe; and
a gasket between the split ring and the pipe.
wherein the vortex-generating bar is threaded and is configured to engage the split ring threads, to allow for adjustment of the depth of insertion of the vortex-generating bar in the pipe.

15. The vortex flowmeter of claim 14, further comprising an electronics enclosure carried by the split ring.

16. The vortex flowmeter of claim 15, wherein the electronics enclosure comprises a base that is coupled to the split ring and is separable from an upper portion.

17. The vortex flowmeter of claim 16, wherein the upper portion of the electronics enclosure is configured to be rotated along with the vortex-generating bar.
